(19) United States
(12) Patent Application Publication
(10) Pub. No.: US 2014/0201356 A1
(43) Pub. Date: Jul. 17, 2014

(54) MONITORING SYSTEM OF MANAGING CLOUD-BASED HOSTS AND MONITORING METHOD USING FOR THE SAME

(71) Applicant: DELTA ELECTRONICS, INC., Taoyuan County (TW)

(72) Inventors: Jui-Tsung HUNG, Taoyuan County (TW); Ping-Hui HSU, Taoyuan County (TW)

(73) Assignee: DELTA ELECTRONICS, INC., Taoyuan County (TW)

(21) Appl. No.: 14/041,370

(22) Filed: Sep. 30, 2013

(30) Foreign Application Priority Data
Jan. 16, 2013 (TW) 10210576

(51) Int. Cl. H04L 12/26

(52) U.S. Cl. CPC H04L 43/0876
USPC 709/224

(57) ABSTRACT

A monitoring system includes a monitoring management server (MMS), a monitoring agent server, a database, and a plurality of hosts, wherein, the monitoring agent server is directly connected to the database. The monitoring agent server simultaneously serves several hosts, collects status information from the hosts, and the stores the status information into the database so that an administrator can monitor and inquire the status information. Therefore, the monitoring agent server is used to as a transmission interface between the hosts and the database.

### BACKGROUND

1. Technical Field

The present disclosure relates generally to a monitoring system and a monitoring method using for the same, and more particularly to a monitoring system and a monitoring method using for the same that are provided to overcome the problem of overloading of the database connected to multiple hosts.

2. Description of Related Art

In general, a cloud-based data center has a variety of hosts, such as physical machine (PM), virtual machine (VM), network switch, router, uninterruptible power supply (UPS), firewall, and so on for processing different information.

In order to conveniently manage and monitor statuses of the data center, the administrator usually installs sensors inside the hosts and uses the corresponding software to monitor various data of the hosts, such as temperature, humidity, fan speed, CPU, memory, network condition, hard disk capacity, and so on. In addition, the sensed and monitored information are regularly replied and stored in a database of the data center so that the administrator can access the data in the database to monitor all information of the hosts.

In the existing data centers, the hosts are usually directly connected to the corresponding database, and also each host replies its own information to the database and the information is stored in the database. That is, the hosts need to continually detect their own information and regularly reply the detected information to the database. However, the amount of the host is too much, the reply operation is too frequent, or the data quantity transmitted at the same time is too large that may cause bandwidth congestion so as to lose the accessed data.

Because the amount of the external transmission channel connected to the database gets larger as the amount of the host gets larger, the bandwidth congestion would occur when the amount of the hosts provided to transmit data at the same time. Also, the database would be damaged if overloading of the database occurs.

### SUMMARY

An object of the present disclosure is to provide a monitoring system of managing cloud-based hosts and monitoring method using for the same that a monitoring agent server is provided to simultaneously serve a plurality of hosts to be a transmission interface between the hosts and a database so as to overcome the overloading of the database because of the amount of the host connected to the database is too much.

In order to achieve the above-mentioned object, the monitoring system mainly includes a monitoring management server, a monitoring agent server, a database, and a plurality of hosts. The monitoring agent server is connected to the database. The monitoring agent server can simultaneously serve a plurality of hosts to collect status information of the hosts and store the status information in the database so that the administrator can monitor and inquire the hosts.

Accordingly, the present disclosure has following features and advantages. At least one monitoring agent server is used to be a transmission interface between the hosts and the database so as to efficiently control the amount of I/O interface of the database, thus avoiding overloading of the database from the too much used hosts directly connected to the database.

Furthermore, the monitoring agent server can be allocated by the monitoring management server to the assigned hosts. Accordingly, the monitoring management server is provided to inquire which host is served by which monitoring agent server so that the administrator can easily inquire the information of the specific host.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a system structure view of a monitoring system according to a first preferred embodiment of the present disclosure;

FIG. 2 is a system structure view of a monitoring system according to a second preferred embodiment of the present disclosure;

FIG. 3 is a block diagram of a monitoring management server according to a preferred embodiment of the present disclosure;

FIG. 4 is a block diagram of a host according to a preferred embodiment of the present disclosure;

FIG. 5 is a block diagram of a monitoring agent server according to a preferred embodiment of the present disclosure;

FIG. 6 is a schematic view of a data pool according to a preferred embodiment of the present disclosure;

FIG. 7 is a flowchart of a monitoring procedure according to a preferred embodiment of the present disclosure;

FIG. 8 is a flowchart of a simulation procedure according to a preferred embodiment of the present disclosure;

FIG. 9 is a flowchart of a registering procedure of the monitoring agent server according to a preferred embodiment of the present disclosure;

FIG. 10 is a flowchart of a transmission procedure according to a first preferred embodiment of the present disclosure; and

FIG. 11 is a flowchart of a transmission procedure according to a second preferred embodiment of the present disclosure.

### DETAILED DESCRIPTION

Reference will now be made to the drawing figures to describe the present invention in detail.

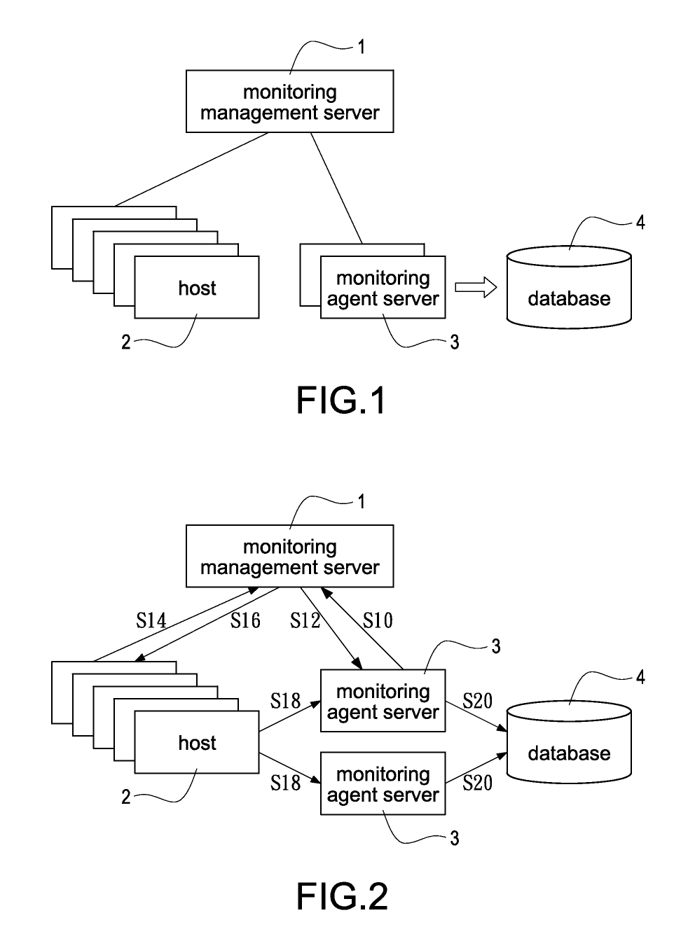

Reference is made to FIG. 1 and FIG. 2 which are block diagrams of a monitoring system according to a first preferred embodiment and a second preferred embodiment of the present disclosure, respectively. The monitoring system mainly includes a monitoring management server (MMS) 1, a plurality of hosts 2, at least one monitoring agent server 3, and a database 4. The monitoring management server 1 is connected to the hosts 2 and the at least one monitoring agent server 3. In addition, at least one monitoring agent server 3 is connected to the database 4.

In this embodiment, the monitoring management server 1, the host 2, the monitoring agent server 3, and the database 4 can be considered as a node, respectively, and the nodes can be realized by the physical machine (PM) or virtual machine (VM), but not limited. In particular, the monitoring system can arbitrarily assign one or more nodes to the monitoring agent server 3 according to actual demands. Hence, when the virtual machine is realized to be the monitoring agent server 3, the same physical machine can simultaneously play roles of the host 2 and the monitoring agent server 3. That is, the hosts 2 and the monitoring agent servers 3 are not limited to be realized by the physical machine and only one thereof. Hence, the same physical machine can simultaneously play different roles to increase system flexibility.

Especially, in one embodiment, the at least one monitoring agent server 3 can be an independent physical machine which are operated in the data center of the cloud system. In another embodiment, the monitoring management server 1 can assign one of the hosts 2 to simulate the monitoring agent server 3 and the same physical machine can simultaneously play roles of the host 2 and the monitoring agent server 3.

In this embodiment, the amount of the monitoring agent server 3 is less than that of the host 2 and each monitoring agent server 3 can serve multiple hosts 2 to be the transmission interface between the hosts 2 and the database 4 so as to significantly decrease the amount of the external transmission channel connected to the database 4 and reduce loading of the database 4. As shown in FIG. 1, the amount of the host 2 is five and the amount of the monitoring agent server 3 is two, and the five hosts 2 are served by the two monitoring agent servers 3. Hence, the database 4 only provides two external transmission channels rather than five ones, thus efficiently reducing loading of the database 4. However, the embodiment is only exemplified but is not intended to limit the scope of the disclosure. In particular, the amount of the host 2 and the monitoring agent server 3 is determined according to actual demands. For convenience, it is assumed that the amount of the host 2 and the amount of the monitoring agent server 3 are both one.

As shown in FIG. 2, after starting, the monitoring agent server 3 registers to the monitoring management server 1 (S10) and receives a configuration information transmitted from the monitoring management server 1 (S12) to execute a configuration operation according to the configuration information. At the same time, the host 2 also registers to the monitoring management server 1 (S14) and receives an allocation information transmitted from the monitoring management server 1 after registering (S16). Accordingly, the host 2 can recognize that which monitoring agent server 3 is used to transmit data from the host 2 to the database 4. In this embodiment, the host 2 transmits status information thereof, such as temperature, humidity, fan speed, CPU status, memory status, network status, hard disk capacity, and so on to the allocated monitoring agent server 3 (S18), and then the allocated monitoring agent server 3 writes the status information of the host 2 into the database 4 (S20).

Especially, the sequence of the step S10 and the S14 are not limited. That is, the monitoring agent server 3 can earlier or later registers than the host 2 or even the monitoring agent server 3 and the host 2 can simultaneously register to the monitoring management server 1.

As mentioned above, the monitoring agent server 3 can be is an independent physical machine or the monitoring agent server 3 can be realized by simulating one of the hosts 2. The assigned host 2 to be simulated as the monitoring agent server 3 also needs to transmit own status information to the allocated monitoring agent server 3. That is, the assigned host 2 is provided to play roles of collecting monitoring data from other hosts as well as transmitting own monitoring data.

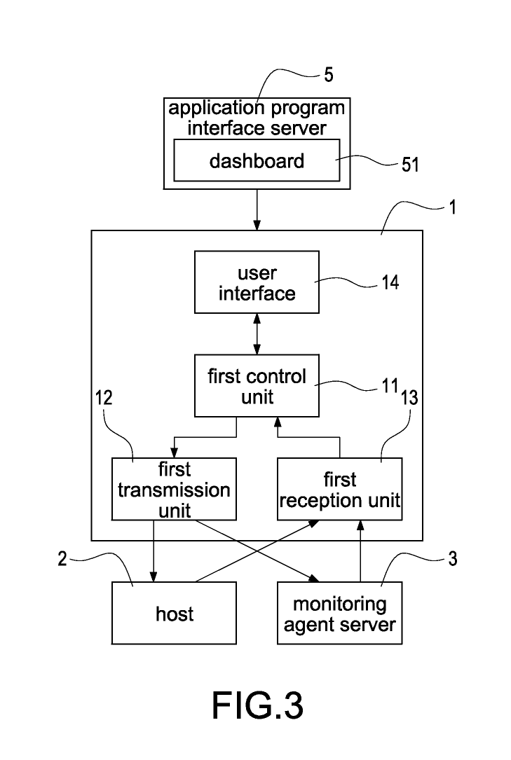

Reference is made to FIG. 3 which is a block diagram of a monitoring management server according to a preferred embodiment of the present disclosure. In this embodiment, the monitoring management server 1 mainly includes a first control unit 11, a first transmission unit 12, and a first reception unit 13, in which, the first control unit 11 is connected to the first transmission unit 12 and the first reception unit 13.

The first control unit 11 is used to process various internal data of the monitoring management server 1. The first reception unit 13 is connected to the host 2 and the monitoring agent server 3 to receive registration requests transmitted from the host 2 and the monitoring agent server 3, respectively. The first transmission unit 12 is connected to the host 2 to send the allocation information to the registered host 2 so that the host 2 can recognize that which monitoring agent server 3 is used. If there is no monitoring agent server 3 can be assigned, however, the monitoring management server 1 can assign one of the hosts 2 to simulate the monitoring agent server 3 by sending an assignation instruction from the first transmission unit 12. In addition, the first transmission unit 12 is also connected to the monitoring agent server 3 to send the configuration information to the registered monitoring agent server 3 so that the monitoring agent server 3 is configured according to the configuration information.

In the present disclosure, the monitoring management server 1 is provided to allocate the monitoring agent server 3 to serve the host 2 and notify the monitoring agent server 3 that which hosts 2 need to be served. Hence, the administrator can inquire the monitoring management server 1 to easily know that a specific host is served by which monitoring agent server 3 so that the status information of the specific host can be inquired.

As shown in FIG. 3, the monitoring management server 1 further includes a user interface 14 connected to the first control unit 11, which is operated to inquire the status information of the host 2 by the administrator. More specifically, the administrator operates the monitoring management server 1 through the user interface 14, such as a browser to connect to the monitoring agent server 3 or the database 4 to inquire the status information of the host 2.

In addition, the monitoring system further includes an application program interface server 5 connected to the monitoring management server 1. The application program interface server 5 can provide a physical dashboard 51 so that the administrator can operate the dashboard 51 to connect to and login the monitoring management server 1 to inquire the status information of the host 2. However, the embodiment is only exemplified but is not intended to limit the scope of the disclosure.

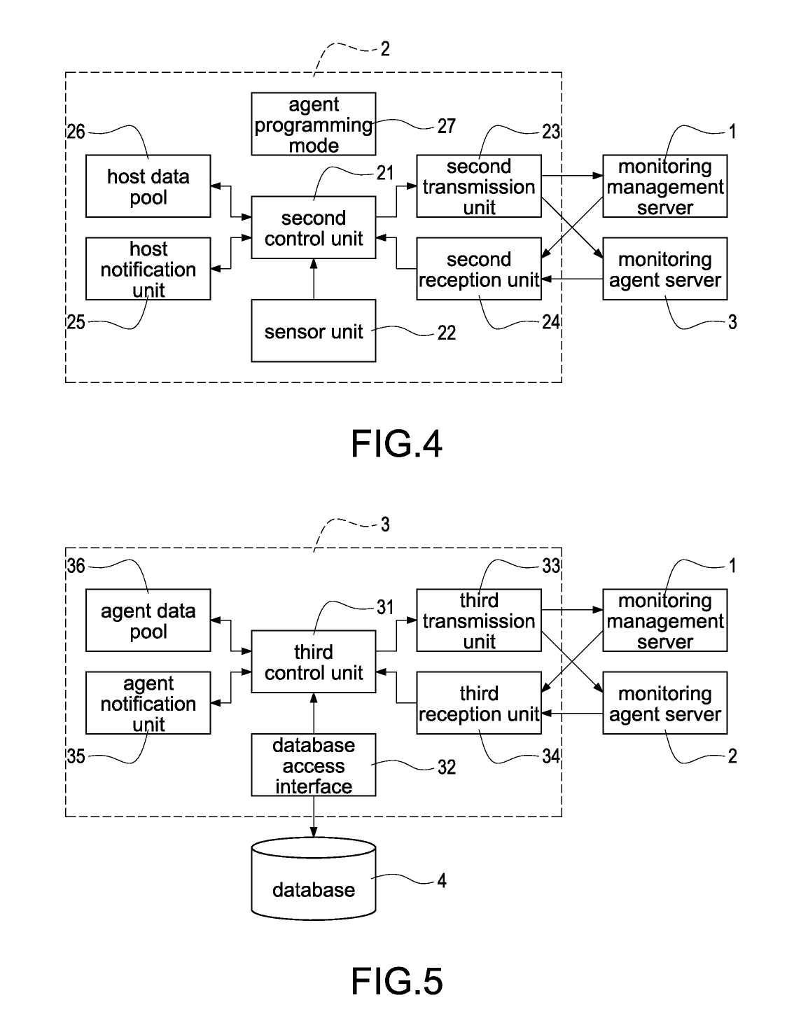

Reference is made to FIG. 4 which is a block diagram of a host according to a preferred embodiment of the present disclosure. The host 2 mainly includes a second control unit 21, a sensor unit 22, a second transmission unit 23, and a second reception unit 24, in which, the second control unit 21 is connected to the sensor unit 22, the second transmission unit 23, and the second reception unit 24.

The second control unit 21 is used to process various internal data of the host 2. The sensor unit 22 is used to sense various data of the host 2, such as temperature, humidity, fan speed, CPU status, memory status, network status, hard disk capacity, and so on to generate the status information. The second transmission unit 23 is connected to the monitoring management server 1 to send the registration request to the monitoring management server 1. In addition, the second transmission unit 23 is also connected to the monitoring agent server 3 to transmit the data sensed by the sensor unit 22 to the monitoring agent server 3. The second reception unit 24 is connected to the monitoring management server 1 to receive the allocation information transmitted from the monitoring management server 1 so that the host 2 can recognize that which monitoring agent server 3 is used. If there is no monitoring agent server 3 can be assigned, however, the second reception unit 24 can receive the assignation instruction transmitted from the monitoring management server 1 to simulate the assigned host 2 as the monitoring agent server 3. In addition, the first transmission unit 12 is also connected to the monitoring agent server 3 to send the configuration information to the registered monitoring agent server 3 so that the monitoring agent server 3 is configured. In addition, the second reception unit 24 is also connected to the monitoring agent server 3 so that the host 2 can receive an acknowledgement character (ACK) transmitted from the monitoring agent server 3 through the second reception unit 24 after the monitoring agent server 3 successfully receives the status information.

As shown in FIG. 4, the host 2 further includes a host notification unit 25 connected to the second control unit 21. In this present disclosure, the status information generated from the sensor unit 22 is first transmitted to the second control unit 21 to be judged and then transmitted to the monitoring agent server 3. When the second control unit 21 judges that the transmitted status information is abnormal, namely, the host 2 is abnormal, the host 2 notifies the administrator through the host notification unit 25. For example, when the host 2 is abnormal due to overheated temperature, overused CPU, or blocked network bandwidth, the host notification unit 25 is used by the host 2 to send messages or E-mails, or generate a corresponding event record in a server, such as the monitoring management server 1 so that the administrator can realize that the host 2 is in the abnormal conditions.

The host 2 further includes a host data pool 26 connected to the second control unit 21. The host data pool 26 is used to temporarily store the status information sensed by the sensor unit 22 before the status information is transmitted to the monitoring agent server 3 (detailed description below).

Reference is made to FIG. 5 which is a block diagram of a monitoring agent server according to a preferred embodiment of the present disclosure. The monitoring agent server 3 mainly includes a third control unit 31, a database access interface 32, a third transmission unit 33, and a third reception unit 34, in which, the third control unit 31 is connected to the database access interface 32, the third transmission unit 33, and the third reception unit 34.

The third control unit 31 is used to process various internal data of the monitoring agent server 3. The monitoring agent server 3 is connected to the database 4 via the database access interface 32 so that the monitoring agent server 3 writes the collected status information into the database 4. The third transmission unit 33 is connected to the monitoring management server 1 to send the registration request to the monitoring management server 1. In addition, the third transmission unit 33 is also connected to the host 2 to transmit the acknowledgement character (ACK) to the host 2. The third reception unit 34 is connected to the monitoring management server 1 to receive the allocation information transmitted from the monitoring management server 1 after registering. In addition, the third reception unit 34 is also connected to the host 2 to receive the status information transmitted from the host 2.

As shown in FIG. 5, the monitoring agent server 3 is connected to one host 2 that is only exemplified further demonstration. In this embodiment, the monitoring agent server 3 can simultaneously serve multiple hosts 2 to simultaneously collect the status information of the served hosts 2. Hence, the third transmission unit 33 and the third reception unit 34 are used to simultaneously connect to the served hosts 2.

Especially, because the monitoring agent server 3 can be realized by simulating the host 2, the host 2 further has the database access interface 32 (not shown) so that the simulated monitoring agent server 3 (by simulating the host 2) can connect to the database 4 and write the status information of the host 2 into the database 4.

As shown in FIG. 4 again, the host 2 further includes an agent programming mode 27. When the monitoring management server 1 assigns the host 2 to be simulated as the monitoring agent server 3, the agent programming mode 27 is provided to execute the simulation operation. In this condition, the assigned host 2 registers to the monitoring management server 1 by the host identify and also registers to the monitoring management server 1 by the monitoring agent server identify. More specifically, the non-assigned host 2 cannot directly connect to the database 4. Although all hosts 2 have the database access interface 32 therein, the database access interface 32 of the non-assigned host 2 is not able to be used.

As shown in FIG. 5, the monitoring agent server 3 further includes an agent notification unit 35 connected to the third control unit 31. After the monitoring agent server 3 collects the status information of the host 2, the collected status information is transmitted to the third control unit 31. When the third control unit 31 judges that the collected status information is abnormal, namely, the host 2 is abnormal, the monitoring agent server 3 notifies the administrator through the agent notification unit 35. The agent notification unit 35 is used by the monitoring agent server 3 to send messages or E-mails, or generate a corresponding event record in a server so that the administrator can realize that the host 2 is in the abnormal conditions.

The monitoring agent server 3 further includes an agent data pool 36 connected to the third control unit 31. The agent data pool 36 is used to temporarily store the collected status information before the collected status information is transmitted to the database 4 (detailed description below).

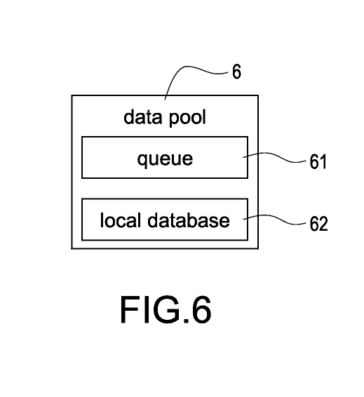

Reference is made to FIG. 6 which is a schematic view of a data pool according to a preferred embodiment of the present disclosure. As mentioned above, the host 2 and the monitoring agent server 3 has a data pool 6, respectively, namely, the host 2 has the host data pool 26 and the monitoring agent server 3 has the agent data pool 36. As shown in FIG. 6, the data pool 6 includes a queue 61 and a local database 62. The queue 61 is used to sort the data to be processed and the local database 62 is used to temporarily store the status information before the status information is successfully transmitted.

For example, the host 2 is provided to transmit the status information sensed by the sensor unit 22 to the monitoring agent server 3. If the monitoring agent server 3 does not been allocated to the host 2 or the monitoring agent server 3 is damaged, the host 2 will temporarily store the status information in the local database 62 of the host data pool 26 so as to ensure the status information cannot lose before being transmitted. In addition, the monitoring agent server 3 is used to write the collected status information into the database 4. If the database 4 is damaged, the monitoring agent server 3 will temporarily store the collected status information in the local database 62 of the agent data pool 36 so as to ensure the status information cannot lose before being transmitted. Accordingly, the local database 62 is used to efficiently enhance monitoring security and ensure data completeness.

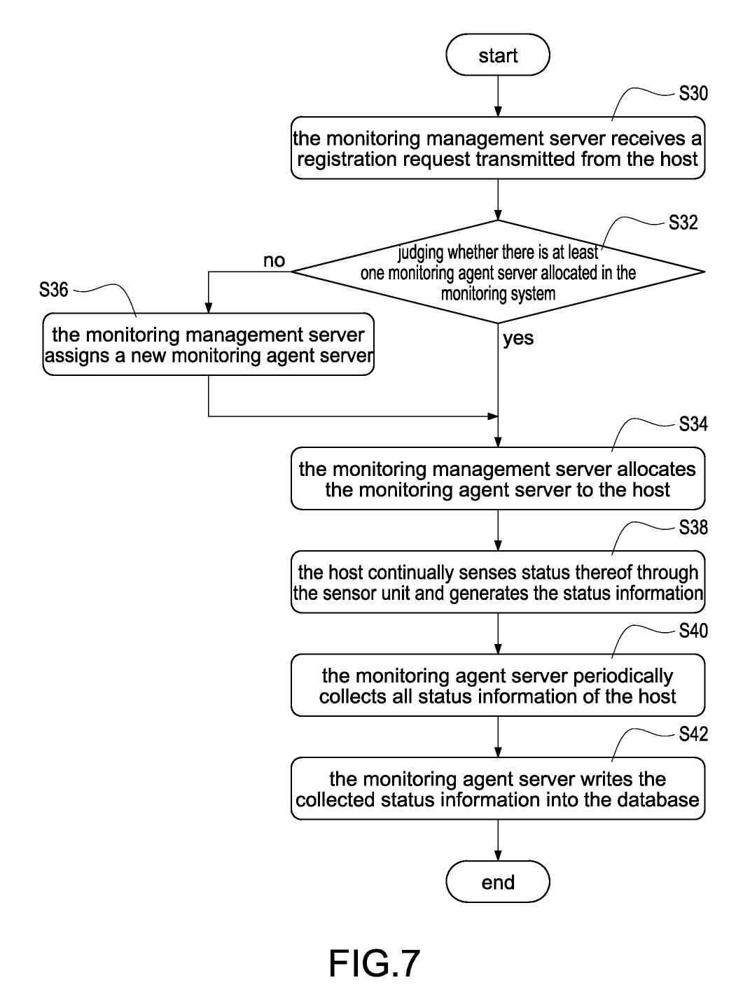

Reference is made to FIG. 7 which is a flowchart of a monitoring procedure according to a preferred embodiment of the present disclosure. The monitoring method is used for the monitoring system of managing cloud-based hosts. First, the monitoring management server 1 receives a registration request transmitted from the host 2 (S30). After the host 2 registered, the monitoring management server 1 judges whether there is at least one monitoring agent server 3 which is allocated in the monitoring system (S32). If there is at least one monitoring agent server 3 which is allocated, the monitoring management server 1 allocates the monitoring agent server 3 to the registered host 2 (S34). If the monitoring agent server 3 cannot be allocated, the monitoring management server 1 assigns a new monitoring agent server 3 (S36). Especially, in the step (S36), the monitoring management server 1 can start any one physical server to play a role of the monitoring agent server 3. In addition, the monitoring management server 1 can also assign any one of the hosts 2 in the monitoring system to execute the agent programming mode 27 so as to be simulated as the monitoring agent server 3. However, the embodiment is only exemplified but is not intended to limit the scope of the disclosure.

In addition, the physical server and simulated monitoring agent server 3 can be combined to use so as to enhance system efficiency. For example, if the monitoring agent server 3 cannot be allocated, the monitoring management server 1 can first assign any one of the hosts 2 to be simulated as the monitoring agent server 3 and then the simulated monitoring agent server 3 is allocated to be used by the registered host 2 so as to quickly overcome the problem of lack of the allocated monitoring agent server 3. At the same time, the monitoring management server 1 can start one physical server to be a new monitoring agent server 3. After the new monitoring agent server 3 is started, the new monitoring agent server 3 is used instead of the simulated monitoring agent server 3 to serve the host 2. Afterward, the simulated monitoring agent server 3 can be removed to make only the new monitoring agent server 3 serve the host 2. Also, the simulated monitoring agent server 3 can be retained to have functions of the host and the agent server. Accordingly, the simulated monitoring agent server 3 can be directly and quickly allocated without further assigning other hosts when the monitoring system needs provisional agent server.

After the step (S34), the host 2 continually senses status thereof through the sensor unit 22 and generates the status information (S38). Afterward, the monitoring agent server 3 periodically collects all status information of the host 2 (S40). Finally, the monitoring agent server 3 writes the collected status information into the database 4 (S42). For example, it is assumed that the amount of the host 2 is one hundred and each monitoring agent server 3 can simultaneously serve twenty hosts 2. Hence, the database 4 only provides five external transmission channels rather than one hundred ones. That is, the database 4 can connect to the five monitoring agent server 3 via the five external transmission channels (5×20=100) to acquire status information of all hosts 2, thus significantly reducing loading of the database 4 and the risk of overloading.

Especially, in the step (S32), the monitoring management server 1 judges whether there is at least one monitoring agent server 3 which is allocated in the monitoring system. If there is at least one monitoring agent server 3 which is allocated, the monitoring management server 1 further judges whether the amount of the allocated monitoring agent server 3 has reached its upper limit (twenty ones as assumed above). If the amount of the allocated monitoring agent server 3 has not reached its upper limit, the monitoring management server 1 can allocate the available monitoring agent server 3 to the registered host 2 and then the amount of the allocated monitoring agent server 3 is added by one.

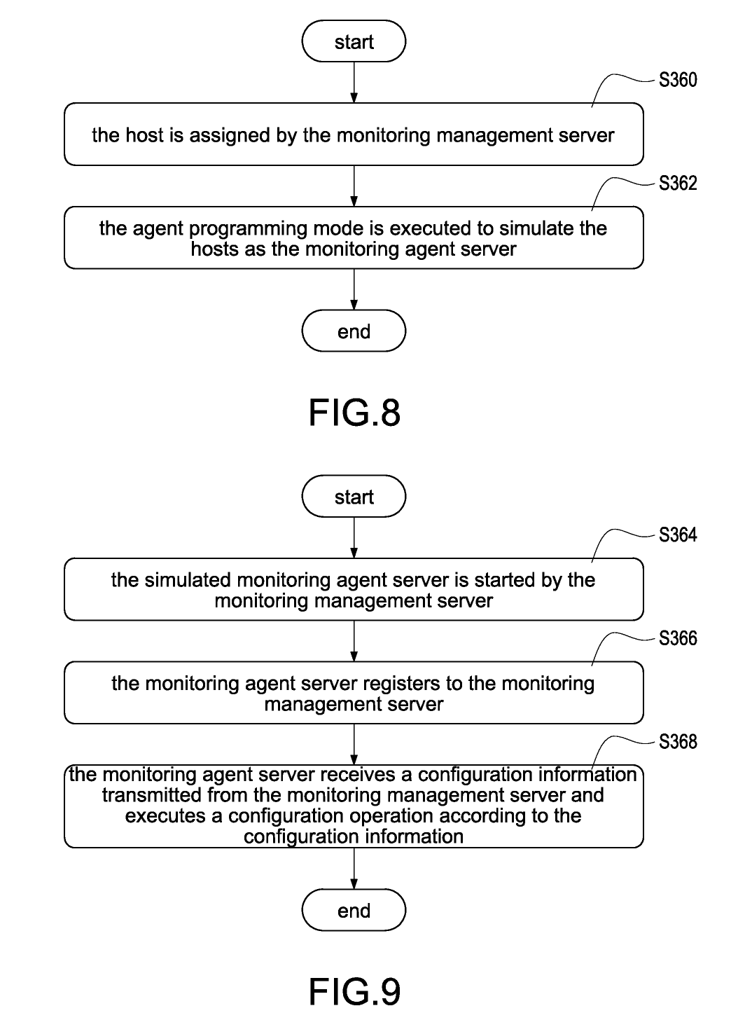

Reference is made to FIG. 8 and FIG. 9 which are flowcharts of a simulation procedure and registering procedure of the monitoring agent server according to a preferred embodiment of the present disclosure, respectively. As mentioned above, if the monitoring agent server 3 is realized by simulating one of the hosts 2 in the step (S36), the host 2 is assigned by the monitoring management server 1 (S360), and the agent programming mode 27 is executed to simulate the hosts 2 as the monitoring agent server 3 (S362). If the monitoring agent server 3 is realized by assigning a physical server, the monitoring management server 1 directly starts the physical server to play a role of the monitoring agent server 3 in the step (S360).

As shown in FIG. 9, after the step (S36), not only the assigned physical server but also the simulated monitoring agent server 3 both need to be started by the monitoring management server 1 (S364). Afterward, the monitoring agent server 3 registers to the monitoring management server 1 (S366). After registering, the monitoring agent server 3 receives a configuration information transmitted from the monitoring management server 1 and then executes a configuration operation according to the configuration information (S368). After the configuration operation is completed, the monitoring agent server 3 can be successfully connected to the database 4 and allocated to the host 2, and then monitoring agent server 3 periodically collects all status information of the host 2 and writes the collected status information into the database 4.

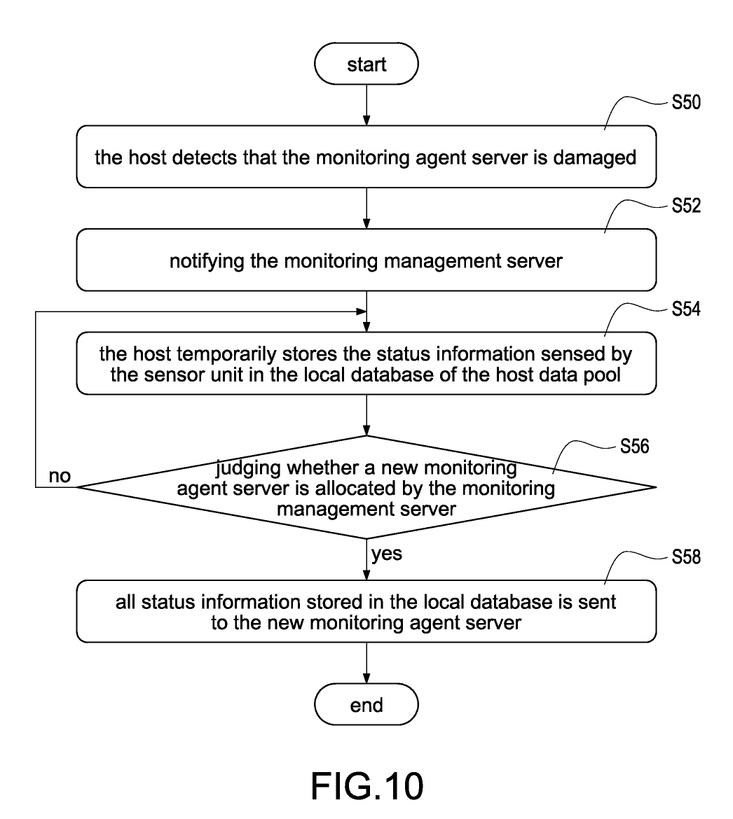

Reference is made to FIG. 10 which is a flowchart of a transmission procedure according to a first preferred embodiment of the present disclosure. Once the monitoring agent server 3 is damaged, the served host 2 can detect that the monitoring agent server 3 is damaged (S50) and then notify the monitoring management server 1 (S52). Afterward, the host 2 temporarily stores the status information sensed by the sensor unit 22 in the local database 62 of the host data pool 26 (S54), and then continually judges whether a new monitoring agent server 3 is allocated by the monitoring management server 1 (S56). Before the new monitoring agent server 3 is allocated to the host 2, the host 2 continually executes steps from the step (S54) to the step (S56). That is, the host 2 continually stores the status information in the local database 62 and judges whether a new monitoring agent server 3 is allocated.

When the new monitoring agent server 3 is allocated to the host 2, all status information stored in the local database 62 is sent to the new monitoring agent server 3 (S58) and then the status information is written to the database 4.

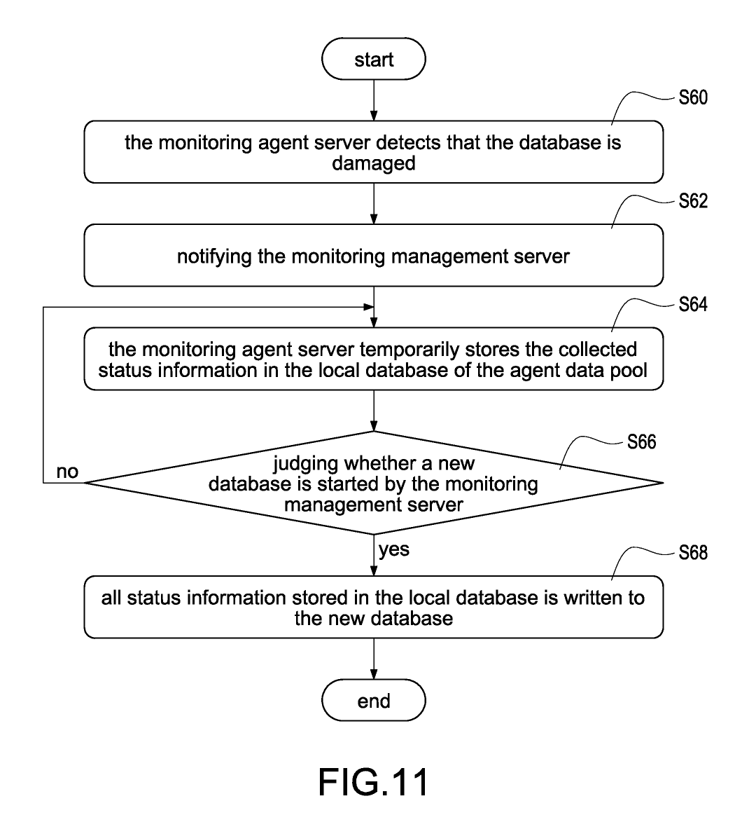

Reference is made to FIG. 11 which is a flowchart of a transmission procedure according to a second preferred embodiment of the present disclosure. Once the database 4 is damaged, the monitoring agent server 3 can immediately detect that the database 4 is damaged (S60) and then immediately notify the monitoring management server 1 (S62). Afterward, the monitoring agent server 3 temporarily stores the collected status information in the local database 62 of the agent data pool 36 (S64) and then continually judges whether a new database 4 is started by the monitoring management server 1 (S66). Before the new database 4 is started, the monitoring agent server 3 continually executes steps from the step (S64) to the step (S66). That is, the monitoring agent server 3 continually stores the collected status information in the local database 62 and judges whether a new database 4 is started.

When the new database 4 is started, all status information stored in the local database 62 is written to the new database 4 (S68). Also, if necessary, the status information stored in the local database 62 can be deleted to avoid the insufficient capacity thereof.

The monitoring system of managing cloud-based hosts and the method using for the same are provided to easily inquire the status information of the hosts 2. Also, the monitoring agent server 3 is provided to be a transmission interface between the hosts 2 and the database 4. Accordingly, the problems of too-much host quantity, too-frequent reply operation, too-large data quantity, and overloading of the database 4 can be overcome.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A monitoring system of managing cloud-based hosts, comprising:
a plurality of hosts, each host having a sensor unit configured to sense a status of the host and generate a status information according to the status of the host;
a database;
a monitoring agent server connected to the database; and
a monitoring management server configured to receive registration requests transmitted from the hosts and the monitoring agent server, and configured to allocate the registered monitoring agent server to serve the corresponding registered hosts;
wherein the monitoring management server is a transmission interface between the hosts and the database, and the monitoring management server is configured to collect the status information of the corresponding registered hosts and write the collected status information into the database.

2. The monitoring system in claim 1, wherein the monitoring management server comprises:
a first reception unit connected to the hosts and the monitoring agent server, and configured to receive the registration requests transmitted from the hosts and the monitoring agent server;
a first transmission unit connected to the hosts and the monitoring agent server, and configured to allocate the registered monitoring agent server to serve the corresponding registered hosts; and
a first control unit connected to the first reception unit and the first transmission unit, and configured to process various data of the monitoring management server.

3. The monitoring system in claim 2, wherein the monitoring management server further comprises:
a user interface connected to the first control unit, and configured to be operated to inquire the status information of the hosts.

4. The monitoring system in claim 1, wherein the monitoring agent server is realized by simulating one of the hosts; each host has an agent programming mode; when one of the hosts is assigned by the monitoring management server to be simulated as the monitoring agent server, the agent programming mode is executed to simulate the assigned host as the monitoring agent server, and the assigned host is directly connected to the database.

5. The monitoring system in claim 1, wherein each of the hosts comprises:
a second transmission unit connected to the monitoring management server and the monitoring agent server, and configured to register to the monitoring management server and transmit the status information to the monitoring agent server;
a second reception unit connected to the monitoring management server, and configured to receive an allocation information transmitted from the monitoring management server; and
a second control unit connected to the second transmission unit and the second reception unit, and configured to process various data of the host.

6. The monitoring system in claim 5, wherein the host comprises a host notification unit connected to the second control unit; when the second control unit is configured to judge that the status information is abnormal, the host is configured to notify administrators.

7. The monitoring system in claim 5, wherein the host comprises a host data pool connected to the second control unit; the host data pool is configured to store the sensed status information.

8. The monitoring system in claim 7, wherein the host data pool comprises a queue and a local database; the queue is configured to sort the data to be processed; the local database is configured to temporarily store the status information when the monitoring agent server does not been allocated to the host or the monitoring agent server is damaged.

9. The monitoring system in claim 1, further comprising:
an application program interface server connected to the monitoring management server;
wherein the application program interface server is configured to provide a dashboard, and the dashboard is configured to be operated to login the monitoring management server and inquire the status information of the hosts.

10. The monitoring system in claim 1, wherein the monitoring agent server comprises:
a third transmission unit connected to the monitoring management server, and configured to register to the monitoring management server;
a third reception unit connected to the monitoring management server and the hosts, and configured to receive an allocation information transmitted from the monitoring management server;
a database access interface connected to the database, and configured to write the collected status information of the hosts into the database; and
a third control unit connected to the third transmission unit, the third reception unit, and the database access interface, and configured to process various data of the monitoring management server.

11. The monitoring system in claim 10, wherein the monitoring agent server further comprises:
an agent notification unit connected to the third control unit; when the third control unit is configured to judge that the collected status information is abnormal, the agent notification unit is configured to notify administrators; and
an agent data pool connected to the third control unit, and configured to store the collected status information of the hosts.

12. The monitoring system in claim 11, wherein the agent data pool comprises a queue and a local database; the queue is configured to sort the data to be processed; the local database is configured to temporarily store the collected status information of the hosts when the database is damaged.

13. A monitoring method using for a monitoring system of managing cloud-based hosts, the monitoring system comprising a monitoring management server, a monitoring agent server, a plurality of hosts, and a database, the monitoring method comprising following steps:
(a) receiving registration requests transmitted from the hosts by the monitoring management server;
(b) judging whether there is at least one monitoring agent server which is allocated in the monitoring system by the monitoring management server;
(c) starting a new monitoring agent server and allocating the new monitoring agent server to the corresponding registered hosts by the monitoring management server when there is no monitoring agent server which is allocated in the monitoring system;
(d) allocating the monitoring agent server to the corresponding registered hosts by the monitoring management server when there is at least one monitoring agent server which is allocated in the monitoring system;
(e) detecting a status of the host and generating a status information according to the status of the host;
(f) collecting the status information of the corresponding hosts by the monitoring agent server; and
(g) connecting the monitoring agent server to the database and writing the collected status information of the hosts into the database.

14. The monitoring method in claim 13, wherein the step (c) comprises:
(c1) assigning one of the hosts and simulating the assigned host to be a new monitoring agent server by the monitoring management server.

15. The monitoring method in claim 14, wherein the step (c) further comprising following steps:
(c2) executing an agent programming mode in the assigned host;
(c3) simulating the assigned host to be the monitoring agent server through the agent programming mode;
(c4) registering to the monitoring management server after the monitoring agent server is started; and
(c5) receiving a configuration information transmitted from the monitoring management server by the monitoring agent server and executing a configuration operation according to the configuration information.

16. The monitoring method in claim 13, wherein the step (c) further comprising following step:
(c1) starting any one physical server in the monitoring system to be the new monitoring agent server by the monitoring management server.

17. The monitoring method in claim 16, wherein the step (c) further comprising following steps:
(c2) registering to the monitoring management server after the monitoring agent server is started; and
(c3) receiving a configuration information transmitted from the monitoring management server by the monitoring agent server and executing a configuration operation according to the configuration information.

18. The monitoring method in claim 13, wherein the step (b) further comprising following steps:
(b1) judging whether there is at least one monitoring agent server which is started; and
(b2) judging whether the amount of the started monitoring agent server has reached its upper limit.

19. The monitoring method in claim 13, further comprising following steps:
(h) notifying the monitoring management server when one of the hosts detects that the monitoring agent server is damaged;
(i) temporarily storing the status information by the host in a local database inside the host;
(j) judging whether a new monitoring agent server is allocated to the host;
(k) repeatedly executing step (i) and step (j) when there is no new monitoring agent server is allocated to the host; and
(l) transmitting the status information stored in the local database to the new monitoring agent server when the new monitoring agent server is allocated to the host.

20. The monitoring method in claim 13, further comprising following steps:
(m) notifying the monitoring management server when the monitoring agent server detects that the database is damaged;
(n) storing the collected status information of the hosts by the monitoring agent server in a local database inside the monitoring agent server;
(o) judging whether there is at least one database which is started by the monitoring agent server;
(p) repeatedly executing step (n) and step (o) when there is no new database is started; and
(q) transmitting the status information of the hosts stored in the local database to the new database by the monitoring agent server when the new database is started.
